(19) United States
(12) Patent Application Publication
(10) Pub. No.: US 2012/0164339 A1
(43) Pub. Date: Jun. 28, 2012

(54) Substrate Liquid Processing Apparatus, Substrate Liquid Processing Method and Computer Readable Recording Medium Having Substrate Liquid Processing Program

(75) Inventors: Mitsunori NAKAMORI, Koshi City (JP); Hidetomo Uemukai, Koshi City (JP); Takayuki Toshima, Koshi City (JP)

(73) Assignee: Tokyo Electron Limited

(21) Appl. No.: 13/334,476

(22) Filed: Dec. 22, 2011

(30) Foreign Application Priority Data
Dec. 27, 2010 (JP) 2010-290163

(51) Int. Cl. B05D 1/02; B05B 1/00; B05D 3/00; B05C 11/00

(52) U.S. Cl. 427/401; 118/612; 118/696; 427/421.1

(57) ABSTRACT

Disclosed are a substrate liquid processing apparatus and a substrate liquid processing method that performs a water-repelling process for a substrate with a water-repellent liquid, and a computer readable recording medium having a substrate liquid processing program. A first diluted water-repellent liquid is generated by mixing a first diluting liquid capable of diluting the water-repellent liquid without hydrolysis and the water-repellent liquid in a mixing tank, and a water-repelling process is performed for a substrate with the first diluted water-repellent liquid. A second diluting liquid capable of diluting the water-repellent liquid is supplied to a middle portion of a first supply path supplying the first diluted water-repellent liquid from the mixing tank. A second diluted water-repellent liquid is generated by diluting the first diluted water-repellent liquid with the second diluting liquid, and the water-repelling process is performed for the substrate with the second diluted water-repellent liquid.

### CROSS-REFERENCE TO RELATED APPLICATIONS

This application is based on and claims priority from Japanese Patent Application No. 2010-290163, filed on Dec. 27, 2010, with the Japanese Patent Office, the disclosure of which is incorporated herein in its entirety by reference.

### TECHNICAL FIELD

The present disclosure relates to a substrate liquid processing apparatus and a substrate liquid processing method that performs a water-repelling process for a substrate with a water-repellent liquid, and a computer readable recording medium that stores a substrate liquid processing program therein.

### BACKGROUND

In the related art, when semiconductor components or flat panel displays are manufactured, a substrate liquid processing apparatus is used to perform a cleaning process or an etching process onto a substrate such as a semiconductor wafer or a liquid crystal substrate with a chemical liquid such as a cleaning agent or an etching agent and thereafter, perform a rinsing process that rinses the cleaned or etched substrate with a rinse liquid such as deionized water, and perform a drying process that dries the substrate attached with the rinse liquid.

In recent years, an aspect ratio has been increased with minuteness of a circuit pattern or an etching mask pattern formed on the surface of the substrate. When the substrate in which the circuit pattern having the high aspect ratio or the etching mask pattern having the high aspect ratio is formed on the surface thereof is rinsed and dried, the circuit pattern or the etching mask pattern may collapse due to the action of surface tension of the rinse liquid attached on the substrate surface.

For this reason, before rinsing the substrate, the substrate is subjected to a water-repelling process with the water-repellent liquid and thereafter, the substrate is rinsed or dried. As described above, by performing the water-repelling process for the substrate before rinsing the substrate, the contact angle of the rinse liquid attached to the substrate is increased to reduce the surface tension, thereby preventing the circuit pattern or the etching mask pattern from collapsing (see, for example, Japanese Patent Application Laid-Open No. 2010-114439).

### SUMMARY

An exemplary embodiment of the present disclosure provides a substrate liquid processing apparatus that performs a water-repelling process for a substrate by using a diluted water-repellent liquid, comprising: a water-repellent liquid supplying source configured to supply a water-repellent liquid; a first diluting liquid supplying source configured to supply a first diluting liquid that is capable of diluting the water-repellent liquid without hydrolysis; a mixing tank configured to generate a first diluted water-repellent liquid by mixing the water-repellent liquid supplied from the water-repellent liquid supplying source and the first diluting liquid supplied from the first diluting liquid supplying source; a substrate processing chamber configured to conduct a water-repelling process for the substrate; a first supply path configured to supply the first diluted water-repellent liquid from the mixing tank; a first supplying mechanism configured to supply the first diluted water-repellent liquid from the mixing tank to the substrate processing chamber through the first supply path; a second diluting liquid supplying source configured to supply a second diluting liquid that is capable of diluting the water-repellent liquid; a second supply path configured to supply the second diluting liquid from the second diluting liquid supplying source; a second supplying mechanism configured to supply the second diluting liquid from the second diluting liquid supplying source to the second supply path; and a mixing unit installed on the first supply path and configured to generate a second diluted water-repellent liquid by mixing the first diluted water-repellent liquid and the second diluting liquid.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a plan view illustrating a substrate liquid processing apparatus.

FIG. 2 is a schematic diagram illustrating a substrate processing chamber.

FIG. 3 is a cross-sectional view illustrating a water-repellent liquid discharge nozzle.

FIG. 4 is a flowchart illustrating a substrate liquid processing method.

FIG. 5 is a diagram illustrating the operation of the substrate processing chamber.

FIG. 6 is a diagram illustrating the operation of the substrate processing chamber.

FIG. 7 is a schematic diagram illustrating another substrate processing chamber.

FIG. 8 is a flowchart illustrating another substrate liquid processing method.

FIG. 9 is a schematic diagram illustrating yet another substrate processing chamber.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

When, for example, a silylation agent such as trimethyl silyl dimethyl amine (TMSDMA) is used as the water-repellent liquid for a water-repelling process of the substrate, there is a concern that the operating costs may be increased because the water-repellent liquid is expensive.

Therefore, the water-repellent liquid (trimethyl silyl dimethyl amine) may be used through a dilution using a diluting liquid such as alcohol or cyclohexanone. However, when trimethyl silyl dimethyl amine is diluted with alcohol or cyclochexanone, there is a concern that hydrolysis is caused to deteriorate a water-repelling ability.

The substrate may be subjected to a water-repelling process while diluting the water-repellent liquid by supplying both the water-repellent liquid (trimethyl silyl dimethyl amine) and the diluting liquid (alcohol or cyclohexanone) to the substrate. However, since the flow rate of the water-repellent liquid is still far smaller than the flow rate of the diluting liquid, it is difficult to adjust the flow rate of the water-repellent liquid having the small flow rate, and the water-repellent liquid and the diluting liquid cannot be mixed with a precise ratio. As a result, there is a concern that the water-repelling process may not be applied uniformly throughout the entire surface of the substrate.

An exemplary embodiment of the present disclosure provides a substrate liquid processing apparatus that performs a water-repelling process for a substrate by using a diluted water-repellent liquid, including: a water-repellent liquid supplying source configured to supply a water-repellent liquid; a first diluting liquid supplying source configured to supply a first diluting liquid that is capable of diluting the water-repellent liquid without hydrolysis; a mixing tank configured to generate a first diluted water-repellent liquid by mixing the water-repellent liquid supplied from the water-repellent liquid supplying source and the first diluting liquid supplied from the first diluting liquid supplying source; a substrate processing chamber configured to conduct a water-repelling process for the substrate; a first supply path configured to supply the first diluted water-repellent liquid from the mixing tank; a first supplying mechanism configured to supply the first diluted water-repellent liquid from the mixing tank to the substrate processing chamber through the first supply path; a second diluting liquid supplying source configured to supply a second diluting liquid that is capable of diluting the water-repellent liquid; a second supply path configured to supply the second diluting liquid from the second diluting liquid supplying source; a second supplying mechanism configured to supply the second diluting liquid from the second diluting liquid supplying source to the second supply path; and a mixing unit installed on the first supply path and configured to generate a second diluted water-repellent liquid by mixing the first diluted water-repellent liquid and the second diluting liquid.

In the above substrate liquid processing apparatus, the mixing unit may be a nozzle installed at an end portion of the first supply path and configured to mix a plurality of fluids therein, and each of the first supply path and the second supply path may be connected to the nozzle.

In the above substrate liquid processing apparatus, the second diluting liquid supplying source may supply a second diluting liquid that hydrolyzes the water-repellent liquid.

The substrate liquid processing apparatus may further include: a rinse liquid supplying mechanism configured to supply a rinse liquid that rinses the substrate; a substitution accelerating liquid supplying mechanism configured to supply a substitution accelerating liquid that accelerates substitution of the rinse liquid and the first or second diluted water-repellent liquid; and a controller configured to control the first supplying mechanism, the rinse liquid supplying mechanism, and the substitution accelerating liquid supplying mechanism, and the controller may perform substitution accelerating by supplying the substitution accelerating liquid to the substrate before and after performing the water repelling process by supplying the first or second diluted water-repellent liquid to the substrate.

Another exemplary embodiment of the present disclosure provides a substrate liquid processing apparatus that performs a water-repelling process for a substrate by using a diluted water-repellent liquid and a substitution accelerating process by supplying a substitution accelerating liquid to the substrate, including: a substrate processing chamber configured to conduct the water-repelling process and the substitution accelerating process for the substrate; a supply unit configured to supply the diluted water-repellent liquid or substitution accelerating liquid to the substrate; a water-repellent liquid supplying source configured to supply the water-repellent liquid; a first diluting liquid supplying source configured to supply a first diluting liquid that is capable of diluting the water-repellent liquid without hydrolysis; a mixing tank configured to generate a first diluted water-repellent liquid by mixing the water-repellent liquid supplied from the water-repellent liquid supplying source and the first diluting liquid supplied from the first diluting liquid supplying source; a first supply path configured to supply the first diluted water-repellent liquid from the mixing tank to the supply unit; a first supplying mechanism configured to supply the first diluted water-repellent liquid from the mixing tank to the supply unit through the first supply path; a second diluting liquid supplying source configured to supply a second diluting liquid that dilutes the first diluted water-repellent liquid and serves as the substitution accelerating liquid; a second supply path configured to supply the second diluting liquid from the second diluting liquid supplying source; a second supplying mechanism configured to supply the second diluting liquid from the second diluting liquid supplying source to the second supply path; a mixing unit installed on the first supply path and configured to generate a second diluted water-repellent liquid by mixing the first diluted water-repellent liquid and the second diluting liquid; and a controller configured to control the first supplying mechanism and the second supplying mechanism. The controller controls to selectively perform the water repelling process that generates the second diluted water-repellent liquid acquired by diluting the first diluted water-repellent liquid supplied from the mixing tank with the second diluting liquid supplied from the second supply path and supplies the generated liquid to the substrate, and perform the substitution accelerating process that supplies only the second diluting liquid supplied from the second supply path to the substrate.

In the above substrate liquid processing apparatus, the mixing unit may be a nozzle installed at an end portion of the first supply path and being capable of mixing a plurality of fluids therein, and each of the first supply path and the second supply path may be connected to the nozzle.

Yet another exemplary embodiment of the present disclosure provides a substrate liquid processing method for water-repelling process of a substrate by using a diluted water-repellent liquid, including: generating a first diluted water-repellent liquid by mixing a first diluting liquid capable of diluting a water-repellent liquid without hydrolysis and the water-repellent liquid in a mixing tank; generating a second diluted water-repellent liquid by mixing the first diluted water-repellent liquid supplied from the mixing tank and a second diluting liquid capable of diluting the water-repellent liquid; and performing the water repelling process by supplying the second diluted water-repellent liquid to the substrate.

In the above substrate liquid processing method, the second diluted water-repellent liquid may be generated by mixing the first diluted water-repellent liquid and the second diluting liquid through a nozzle that capable of mixing a plurality of fluids therein.

In the above substrate liquid processing method, a diluting liquid that hydrolyzes the water-repellent liquid may be used as the second diluting liquid.

In the above substrate liquid processing method, a diluting liquid that accelerates substitution of a rinse liquid and the second diluted water-repellent liquid may be used as the second diluting liquid to omit substitution between the water repelling process and a rinsing process.

In the above substrate liquid processing method, any one of propylene glycol monomethyletheracetate, ethers, and esters may be used as the first diluting liquid, and any one of alcohol and cyclohexanone may be used as the second diluting liquid.

Still another exemplary embodiment of the present disclosure provides a computer readable recording medium having a substrate liquid processing program that, when executed, causes a computer to perform a water-repelling process of a substrate with a diluted water-repellent liquid by using a substrate liquid processing apparatus. The process comprises: generating a first diluted water-repellent liquid by mixing a first diluting liquid capable of diluting a water-repellent liquid without hydrolysis and the water-repellent liquid in a mixing tank, generating a second diluted water-repellent liquid by mixing the first diluted water-repellent liquid supplied from the mixing tank and a second diluting liquid capable of diluting the water-repellent liquid; and performing the water repelling process by supplying the second diluted water-repellent liquid to the substrate.

According to the exemplary embodiments of the present disclosure, the first diluted water-repellent liquid is generated by diluting the water-repellent liquid with the first diluting liquid without hydrolyzing the water-repellent liquid, and the water-repelling process is performed for the substrate with the first diluted water-repellent liquid. As a result, the water-repellent liquid can be precisely mixed with the diluting liquid without hydrolyzing the water-repellent liquid, and the water-repelling process can be performed with an improved condition.

Hereinafter, detailed configurations of a substrate liquid processing apparatus and a substrate liquid processing method used in the substrate liquid processing apparatus according to exemplary embodiments of the present disclosure will be described with reference to the accompanying drawings.

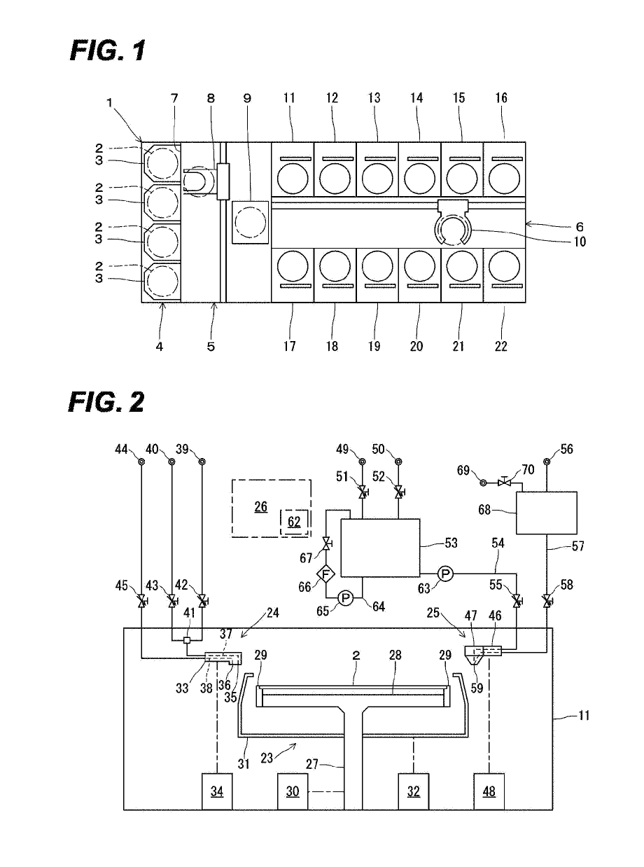

As shown in FIG. 1, in a substrate liquid processing apparatus 1, a substrate carrying-in/out unit 4 is formed at a front end portion integrating a plurality of sheets of (e.g., 25 sheets) substrates 2 (e.g., semiconductor wafers) to carry in and out integrated substrates 2 with respect to a carrier 3. A substrate transporting unit 5 that transports substrates 2 received in carrier 3 is formed at a rear portion of substrate carrying-in/out unit 4, and a substrate processing unit 6 that performs various processes such as cleaning or drying of substrates 2 is formed at the rear portion of substrate transporting unit 5.

Substrate carrying-in/out unit 4 is configured to arrange four (4) carriers 3 at intervals horizontally while carriers 3 being closely attached to a front side wall 7 of substrate transporting unit 5.

Substrate transporting unit 5 is configured to include a substrate transporting device 8 and a substrate delivery platform 9 therein, and transport substrate 2 between any one carrier 3 placed in substrate carrying-in/out unit 4 and substrate delivery platform 9 by using substrate transporting device 8.

Substrate processing unit 6 is configured to include a substrate transporting device 10 at the center thereof and include substrate processing chambers 11 to 22 that are arranged in a forward and backward direction at both left and right sides of substrate transporting device 10.

Substrate processing unit 6 transports substrates 2 between substrate delivery platform 9 of substrate transporting unit 5 and each of substrate processing chambers 11 to 22 one by one by using substrate transporting device 10 and processes substrates 2 one by one by using each of substrate processing chambers 11 to 22.

Substrate processing chambers 11 to 22 each has the same configuration and the configuration of substrate processing chamber 11 will be representatively described. As shown in FIG. 2, substrate processing chamber 11 includes a substrate holding means 23 that rotates substrate 2 while horizontally holding substrate 2, a processing liquid discharge means 24 that discharges a processing liquid (cleaning liquid, rinse liquid, or substitution accelerating liquid) onto the top surface of substrate 2 held by substrate holding means 23, and a water-repellent liquid discharge means 25 that discharges a water-repellent liquid onto the top surface of substrate 2 held by substrate holding means 23. Substrate processing chamber 11 is configured to control substrate holding means 23, processing liquid discharge means 24, and water-repellent liquid discharge means 25 by using a control means 26. Control means 26 is configured to control all of the components of substrate liquid processing apparatus 1 including substrate transporting devices 8 and 10.

In substrate holding means 23, a disk-shaped table 28 is horizontally attached to an upper end portion of a rotational shaft 27 and a plurality of substrate holding bodies 29 that hold substrate 2 horizontally by contacting the periphery of substrate 2 are attached to the periphery of table 28 at intervals in a circumferential direction. A rotation driving mechanism 30 is connected to the rotational shaft 27, and rotational shaft 27 and table 28 are rotated by rotational driving mechanism 30 to rotate substrate 2 held to table 28 by using substrate holding bodies 29. Rotation driving mechanism 30 is connected to control means 26 to be rotationally controlled.

In substrate holding means 23, a cup 31 opened upward is elevatably installed around table 28 and substrate 2 placed on table 28 is surrounded by cup 31 to prevent the processing liquid or substitution accelerating liquid from being scattered into and recover the processing liquid or the substitution accelerating liquid. An elevation mechanism 32 is connected to cup 31 which is elevated relatively upward and downward with respect to substrate 2 by using elevation mechanism 32. Elevation mechanism 32 is connected to control means 26 to be elevatably controlled. Elevation mechanism 32 may elevate substrate 2 and cup 31 relatively each other, and may not be limited to elevate cup 31 but also elevate table 28 as well.

Liquid processing discharge means 24 is placed in such a way that a processing liquid discharge nozzle 33 moves above table 28. A moving mechanism 34 is connected to processing liquid discharge nozzle 33 and processing liquid discharge nozzle 33 is moved between a retracting position which is outside substrate 2 and a start position just above the center of substrate 2 by moving mechanism 34. Moving mechanism 34 is connected to control means 26 to be movably controlled.

In processing liquid discharge means 24, a cleaning and rinsing discharge hole 35 that discharges the cleaning liquid or rinse liquid toward substrate 2 and a substitution discharge hole 36 that discharges the substitution accelerating liquid toward substrate 2 are formed at a front end portion of processing liquid discharge nozzle 33. And a cleaning and rinsing path 37 which is in communication with cleaning and rinsing discharge hole 35 and a substitution path 38 which is in communication with substitution discharge hole 36 are formed within processing liquid discharge nozzle 33.

A cleaning liquid supplying source 39 that supplies the cleaning liquid (chemical liquid) and a rinse liquid supplying source 40 that supplies the rinse liquid (deionized water) are connected to cleaning and rinsing path 37 through a path converter 41. A flow rate regulator 42 is interposed between cleaning liquid supplying source 39 and path converter 41, and the flow rate of the cleaning liquid supplied from processing liquid discharge nozzle 33 to substrate 2 is regulated by flow rate regulator 42. Flow rate regulator 42 is connected to control means 26 and the flow rate is controlled by control means 26. A flow rate regulator 43 is interposed between rinse liquid supplying source 40 and path converter 41, and the flow rate of the rinse liquid supplied from processing liquid discharge nozzle 33 to substrate 2 is regulated by flow rate regulator 43. Flow rate regulator 43 is connected to control means 26 and the flow rate is controlled by control means 26. As described above, processing liquid discharge means 24 serves as a cleaning liquid supplying mechanism that supplies the cleaning liquid to substrate 2 or a rinse liquid supplying mechanism that supplies the rinse liquid to substrate 2.

A substitution accelerating liquid supplying source 44 that supplies the substitution accelerating liquid (isopropyl alcohol (IPA)) is connected to substitution path 38 through a flow rate regulator 45, and the flow rate of the substitution accelerating liquid supplied from processing liquid discharge nozzle 33 to substrate 2 is regulated by flow rate regulator 45. Flow rate regulator 45 is connected to control means 26 and the flow rate is controlled by control means 26. As described above, processing liquid discharge means 24 serves as a substitution accelerating liquid supplying mechanism that supplies the substitution accelerating liquid to substrate 2.

In water-repellent liquid discharge means 25, an arm 46 is placed to move above table 28 and a water-repellent liquid discharge nozzle 47 is attached to a front end portion of arm 46. A moving mechanism 48 is connected to arm 46 and water-repellent liquid discharge nozzle 47 is moved between the retracting position which is outside substrate 2 and the start position just above the center of substrate 2 by moving mechanism 48. Moving mechanism 48 is connected to control means 26 to be movably controlled.

In water-repellent liquid discharge means 25, a water-repellent liquid supplying source 49 that supplies a water repellent liquid (trimethyl silyl dimethyl amine) and a first diluting liquid supplying source 50 that supplies a first diluting liquid (propylene glycol methyl ether acetate (PGMEA)) capable of diluting the water-repellent liquid without hydrolysis are connected to a mixing tank 53 through flow rate regulators 51 and 52, respectively, mixing tank 53 is connected to water-repellent liquid discharge nozzle 47 by a first supply path 54, and a pump 63 and a flow rate regulator 55 are interposed at a middle portion of first supply path 54. Mixing tank 53 includes a circulation path 64, and a pump 65, a filter 66, and a valve 67 are interposed on circulation path 64. Pumps 63 and 65 and valve 67 are connected to control means 26 to be controlled.

Water-repellent liquid discharge means 25 regulates the flow rate of the water-repellent liquid supplied from water-repellent liquid supplying source 49 to mixing tank 53 and the flow rate of the first diluting liquid supplied from first diluting liquid supplying source 50 to mixing tank 53 at a predetermined ratio (e.g., 1:10 to 1:20) by using flow rate regulators 51 and 52 to supply the water-repellent liquid and the first diluting liquid to mixing tank 53. Thereafter, by opening valve 67 and driving pump 65 while closing flow rate regulator 55, the water-repellent liquid and the first diluting liquid are circulated and mixed through circulation path 64 thereby generating a first diluted water-repellent liquid by diluting the water-repellent liquid with the first diluting liquid at a predetermined ratio and the generated first diluted water-repellent liquid is stored in mixing tank 53. In water-repellent liquid discharge means 25, the first diluted water-repellent liquid is supplied from mixing tank 53 to water-repellent liquid discharge nozzle 47 through first supply path 54 by driving pump 63 and the flow rate of the first diluted water-repellent liquid supplied from mixing tank 53 to water-repellent liquid discharge nozzle 47 is regulated by flow rate regulator 55. Flow rate regulators 51, 52, and 55 are connected to control means 26 and the flow rate is controlled by control means 26. As described above, water-repellent liquid discharge means 25 serves as a first supplying mechanism that supplies the first diluted water-repellent liquid from mixing tank 53 to substrate 2 through first supply path 54. The first diluted water-repellent liquid may be supplied not only by using pump 63 but also by pressure of nitrogen gas. The water-repellent liquid and the first diluting liquid may be mixed uniformly not only by circulation but also by mechanical agitation. A tank that stores the water-repellent liquid or the first diluting liquid may be interposed between water-repellent liquid supplying source 49 or first diluting liquid supplying source 50 and mixing tank 53.

In water-repellent liquid discharge means 25, a second diluting liquid supplying source 56 that supplies a second diluting liquid (cyclohexanone) for diluting the water-repellent liquid is connected to water-repellent liquid discharge nozzle 47 by a second supply path 57, and a storage tank 68 and a flow rate regulator 58 are interposed at a middle portion of second supply path 57. A nitrogen gas supplying source 69 that supplies nitrogen gas is connected to storage tank 68 through a valve 70. Valve 70 is connected to control means 26 and openably/closeably controlled by control means 26.

In water-repellent liquid discharge means 25, the nitrogen gas is supplied from nitrogen gas supplying source 69 into storage tank 68 by opening valve 70, the second diluting liquid is pressurized by the nitrogen gas to be supplied from storage tank 68 to water-repellent liquid discharge nozzle 47 through second supply path 57, and the flow rate of the second diluting liquid supplied from second diluting liquid supplying source 56 to water-repellent liquid discharge nozzle 47 is regulated by flow rate regulator 58. Flow rate regulator 58 is connected to control means 26 and flow rate is controlled by control means 26. As described above, water-repellent liquid discharge means 25 serves as a second supplying mechanism that supplies the second diluting liquid from second diluting liquid supplying source 56 through second supply path 57. The second diluting liquid may be supplied not only by pressure of the nitrogen gas but also by using the pump. The second diluting liquid may be supplied directly from second diluting liquid supplying source 56 without passing through storage tank 68.

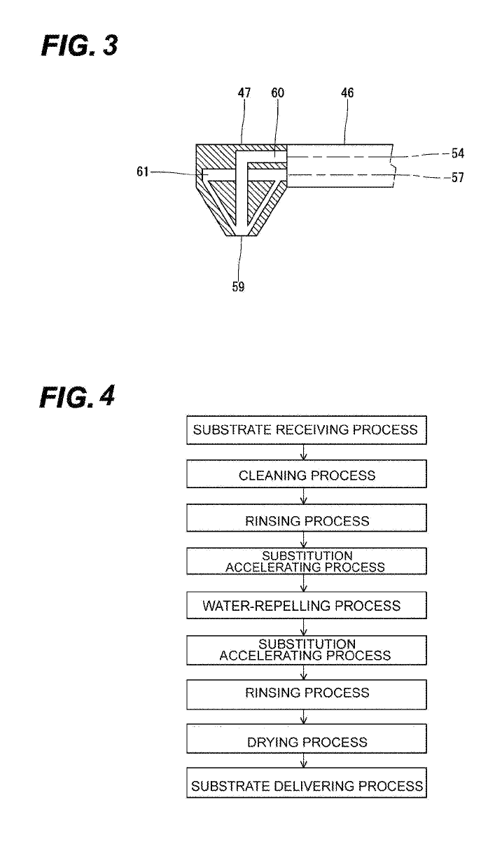

Herein, as shown in FIG. 3, water-repellent liquid discharge nozzle 47 is constituted by a nozzle for two fluids which is attached to a front end portion of arm 46. Water-repellent liquid discharge nozzle 47 is configured such that a discharge hole 59 is formed at the front end portion (lower end portion), a first connection path 60 connected from the center to discharge hole 59 and a second connection path 61 connected from the side to discharge hole 59 are formed therein, and first supply path 54 is connected to first connection path 60 while second supply path 57 is connected to second connection path 61. As described above, a plurality (herein, two kinds) of fluids may be mixed in water-repellent liquid discharge nozzle 47.

In water-repellent liquid discharge means 25, the flow rate of the first diluted water-repellent liquid supplied from first supply path 54 and the flow rate of the second diluting liquid supplied from second supply path 57 are regulated at a predetermined ratio (e.g., 1:9) by flow rate regulators 55 and 58 to generate a second diluted water-repellent liquid by diluting the first diluted water-repellent liquid supplied from first supply path 54 with the second diluting liquid supplied from second supply path 57 around discharge hole 59 of water-repellent liquid discharge nozzle 47, and supply the second diluted water-repellent liquid from discharge hole 59 toward substrate 2. As described above, water-repellent liquid discharge nozzle 47 serves as a mixing unit that mixes the first diluted water-repellent liquid and the second diluting liquid with each other to generate the second diluted water-repellent liquid.

Substrate liquid processing apparatus 1 is configured as described above and in substrate liquid processing apparatus 1, substrate 2 is processed in each of substrate processing chambers 11 to 22 according to a substrate liquid processing program recorded in a (computer) readable recording medium 62 by control means 26. Recording medium 62 may be a medium in which various programs such as the substrate liquid processing program may be recorded. Recording medium 62 may be a semiconductor memory type recording medium such as a ROM or a RAM, and a disk type recording medium such as a hard disk or a CD-ROM.

In substrate liquid processing apparatus 1, substrate 2 is processed as described below according to the flowchart shown in FIG. 4 by the substrate liquid processing program.

First, as shown in FIG. 4, the substrate liquid processing program executes a substrate receiving process of receiving substrate 2 from substrate transporting device 10 to substrate holding means 23 of each of substrate processing chambers 11 to 22.

According to the substrate liquid processing program in the substrate receiving process, in substrate processing chamber 11 shown in FIG. 2, elevation mechanism 32 of substrate holding means 23 is controlled by control means 26 to drop cup 31 to a predetermined position, and thereafter, substrate 2 is received from substrate transporting device 10 to be supported by using substrate holding bodies 29. And then, cup 31 is lifted to a predetermined position by controlling elevation mechanism 32 of substrate holding means 23 by using control means 26.

Next, the substrate liquid processing program executes a cleaning process with the cleaning liquid for substrate 2 received in the substrate receiving process, as shown in FIG. 4.

According to the substrate liquid processing program in the cleaning process, in substrate processing chamber 11 shown in FIG. 2, table 28 of the substrate holding means 23 and substrate 2 held by substrate holding bodies 29 of table 28 are rotated at a predetermined rotational speed by controlling rotation driving mechanism 30 with control means 26, and processing liquid discharge nozzle 33 of processing liquid discharge means 24 is moved above the center of substrate 2 by controlling moving mechanism 34 with control means 26. The cleaning liquid supplied from cleaning liquid supplying source 39 is discharged from liquid processing discharge nozzle 33 toward the top surface of substrate 2 for a predetermined time by opening and controlling flow rate regulator 42 with control means 26, and thereafter, the cleaning liquid stops being discharged from processing liquid discharge nozzle 33 by close-controlling flow rate regulator 42 with control means 26. Processing liquid discharge nozzle 33 may discharge the cleaning liquid to the center of the top surface of substrate 2 while processing liquid discharge nozzle 33 stops above the center of substrate 2 and may discharge the cleaning liquid to the top surface of substrate 2 while moving between a position above the center of substrate 2 and a position above the outer peripheral end edge of substrate 2 by using moving mechanism 34.

Next, the substrate liquid processing program executes a rinsing process of rinsing cleaned substrate 2 with the rinse liquid, as shown in FIG. 4.

According to the substrate liquid processing program in the rinsing process, in substrate processing chamber 11 shown in FIG. 2, in a state where table 28 of the substrate holding means 23 and substrate 2 held by substrate holding bodies 29 of table 28 are rotated at a predetermined rotational speed by controlling rotation driving mechanism 30 with control means 26, processing liquid discharge nozzle 33 of processing liquid discharge means 24 is moved above the center of substrate 2 by controlling moving mechanism 34 with control means 26. The rinse liquid supplied from rinse liquid supplying source 40 is discharged from liquid processing discharge nozzle 33 toward the top surface of substrate 2 for a predetermined time by opening and controlling flow rate regulator 43 with control means 26, and thereafter, the rinse liquid stops being discharged from processing liquid discharge nozzle 33 by close-controlling flow rate regulator 43 with control means 26. Processing liquid discharge nozzle 33 may discharge the rinse liquid to the center of the top surface of substrate 2 while processing liquid discharge nozzle 33 stops above the center of substrate 2 and may discharge the rinse liquid to the top surface of substrate 2 while moving between a position above the center of substrate 2 and a position above the outer peripheral end edge of substrate 2 by using moving mechanism 34.

Next, the substrate liquid processing program executes a substitution accelerating process of accelerating substitution of the rinse liquid with the water-repellent liquid by supplying the substitution accelerating liquid to rinsed substrate 2, as shown in FIG. 4.

According to the substrate liquid processing program in the substitution accelerating process, in substrate processing chamber 11 shown in FIG. 2, in a state where table 28 of the substrate holding means 23 and substrate 2 held by substrate holding bodies 29 of table 28 are rotated at a predetermined rotational speed by controlling rotation driving mechanism 30 with control means 26, processing liquid discharge nozzle 33 of processing liquid discharge means 24 is moved above the center of substrate 2 by controlling moving mechanism 34 with control means 26. The substitution accelerating liquid supplied from substitution accelerating liquid supplying source 44 is discharged from liquid processing discharge nozzle 33 to the top surface of substrate 2 for a predetermined time by opening and controlling flow rate regulator 45 with control means 26, and thereafter, the substitution accelerating liquid stops being discharged from processing liquid discharge nozzle 33 by close-controlling flow rate regulator 45 with control means 26. Processing liquid discharge nozzle 33 may discharge the substitution accelerating liquid to the center of the top surface of substrate 2 while processing liquid discharge nozzle 33 stops above the center of the substrate 2 and may discharge the substitution accelerating liquid to the top surface of substrate 2 while moving between a position above the center of substrate 2 and a position above the outer peripheral end edge of substrate 2 by using moving mechanism 34.

Next, the substrate liquid processing program executes a water-repelling process of repelling water by substituting the substitution accelerating liquid with the water-repellent liquid through supplying the water-repellent liquid to substitution accelerated substrate 2, as shown in FIG. 4.

According to the substrate liquid processing program in the water-repelling process, in substrate processing chamber 11 shown in FIG. 2, in a state where table 28 of the substrate holding means 23 and substrate 2 held by substrate holding bodies 29 of table 28 are rotated at a predetermined rotational speed by controlling rotation driving mechanism 30 with control means 26, water-repellent liquid discharge nozzle 47 of water-repellent liquid discharge means 25 is moved above the center of substrate 2 by controlling moving mechanism 48 with control means 26. The second diluted water-repellent liquid is discharged from water-repellent liquid discharge nozzle 47 to the top surface of substrate 2 for a predetermined time by opening and controlling flow rate regulators 55 and 58 with control means 26, and thereafter, the second diluted water-repellent liquid stops being discharged from water-repellent liquid discharge nozzle 47 by close-controlling flow rate regulators 55 and 58 with control means 26. Water-repellent liquid discharge nozzle 47 may discharge the second diluted water-repellent liquid to the center of the top surface of substrate 2 while water-repellent liquid discharge nozzle 47 stops above the center of substrate 2 and may discharge the second diluted water-repellent liquid to the top surface of substrate while moving between a position above the center of substrate 2 and a position above the outer peripheral end edge of substrate 2 by using moving mechanism 48.

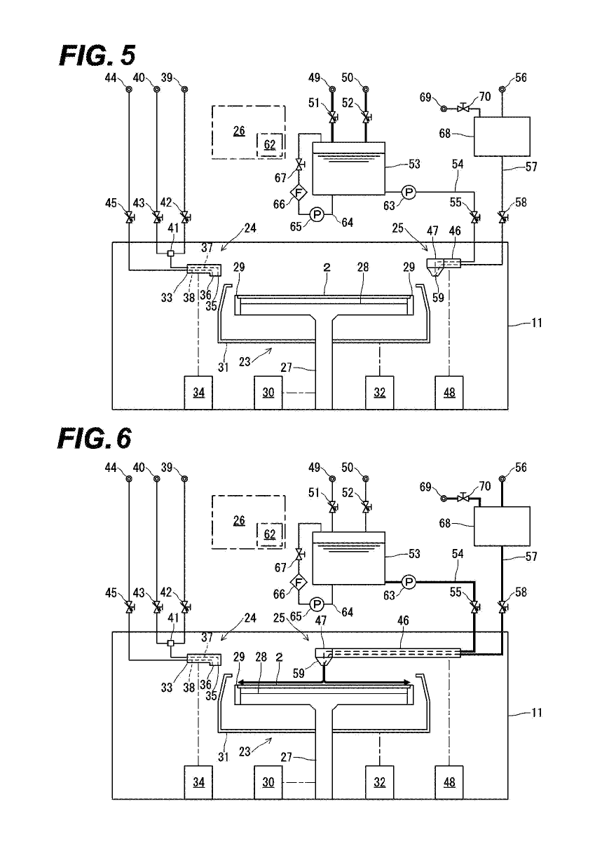

Herein, the substrate liquid processing program generates and stores the first diluted water-repellent liquid acquired by diluting the water-repellent liquid with the first diluting liquid in mixing tank 53 before executing the water-repelling process, as shown in FIG. 5. That is, the substrate liquid processing program regulates the flow rate of the water-repellent liquid and the flow rate of the first diluting liquid at a predetermined ratio by opening and controlling flow rate regulators 51 and 52 by using control means 26 and supplies the water-repellent liquid and the first diluting liquid to mixing tank 53. Thereafter, by controlling valve 67 to be opened and pump 65 to be driven while closing flow rate regulator 55 by using control means 26, the water-repellent liquid and the first diluting liquid are circulated through circulation path 64 to be evenly mixed. As a result, the first diluted water-repellent liquid acquired by diluting the water-repellent liquid with the first diluting liquid at a predetermined ratio is generated and stored in mixing tank 53.

In this case, in substrate liquid processing apparatus 1, since a diluting liquid capable of diluting the water-repellent liquid without hydrolysis is used as the first diluting liquid, the water-repellent ability of the water-repellent liquid can be prevented from being deteriorated due to the hydrolysis of the water-repellent liquid even though the water-repellent liquid and the first diluting liquid are mixed with each other in mixing tank 53.

In substrate liquid processing apparatus 1, since the water-repellent liquid is diluted with the first diluting liquid in mixing tank 53, the water-repellent liquid and the first diluting liquid may be mixed evenly and precisely.

As a result, in a substrate liquid processing method in substrate liquid processing apparatus 1, a water-repelling process of substrate 2 may be conducted with a good condition. In substrate liquid processing apparatus 1, a water-repelling process of substrate 2 is conducted by using the second diluted water-repellent liquid acquired by further diluting the first diluted water-repellent liquid with the second diluting liquid, but is not limited thereto and the water-repelling process for substrate 2 may be conducted by using the first diluted water-repellent liquid.

In the substrate liquid processing program, in the water-repelling process, as shown in FIG. 6, the first diluted water-repellent liquid is supplied from mixing tank 53 to water-repellent liquid discharge nozzle 47 through first supply path 54 by driving-controlling pump 63 with control means 26, and the nitrogen gas is supplied into storage tank 68 from nitrogen gas supplying source 69 by opening-controlling valve 70. And the second diluting liquid is pressurized with the nitrogen gas to be supplied from storage tank 68 to water-repellent liquid discharge nozzle 47 through second supply path 57. The first diluted water-repellent liquid and the second diluting liquid are regulated at a predetermined ratio by opening and controlling flow rate regulators 55 and 58 with control means 26, and the second diluted water-repellent liquid supplied to substrate 2 is generated by diluting the first diluted water-repellent liquid that flows on first supply path 54 with the second diluting liquid supplied from second supply path 57.

As described above, in the substrate liquid processing method in the substrate liquid processing apparatus 1, since the water-repellent liquid is diluted with the first and second diluting liquids in two steps, a dilution ratio may be smaller in each step as compared with the case where the water-repellent liquid is diluted at desired concentration through one-time dilution, such that the water-repellent liquid may be diluted precisely and since the volume of mixing tank 53 where first-step dilution is performed may be small, and substrate liquid processing apparatus 1 may be minimized.

In particular, in the case where the first diluted water-repellent liquid is diluted with the second diluting liquid in water-repellent liquid discharge nozzle 47 that discharges the second diluted water-repellent liquid to substrate 2, since the second diluted water-repellent liquid may be supplied to substrate 2 just after dilution, a diluting liquid (cyclohexanone or alcohol) which hydrolyzes the water-repellent liquid as well as a diluting liquid (propylene glycol monomethyletheracetate, ethers, or esters) which does not hydrolyze the water-repellent liquid (trimethyl silyl dimethyl amine) may be used as the second diluting liquid, such that degrees of freedom in selecting the second diluting liquid may be increased. As a result, an operating cost of substrate liquid processing apparatus 1 may be reduced by, for example, using a low-priced diluting liquid.

Next, the substrate liquid processing program executes the substitution accelerating process of accelerating substitution of the water-repellent liquid with the rinse liquid by supplying the substitution accelerating liquid to substrate 2 having been subjected to the water-repelling process, as shown in FIG. 4. In the substitution accelerating process performed after the water-repelling process, the same processing as the substitution accelerating process performed before the water-repelling process is performed.

Next, the substrate liquid processing program executes the rinsing process of rinsing substitution-accelerated substrate 2 with the rinse liquid, as shown in FIG. 4. In the rising process performed after the water-repelling process, the same processing as the rinsing process performed before the water-repelling process is performed.

Next, the substrate liquid processing program executes a drying process of drying rinsed substrate 2 as shown in FIG. 4.

In the substrate liquid processing program in the drying process, table 28 of substrate holding means 23 and substrate 2 held by substrate holding bodies 29 of table 28 are rotated at a higher rotational speed than the up-to-now liquid processing operations (cleaning, rinsing, substitution accelerating, and water-repellent operations) by controlling rotation driving mechanism 30 with control means 26 to remove the rinse liquid from the top surface of substrate 2 through using centrifugal force, in substrate processing chamber 11 shown in FIG. 2.

Finally, the substrate liquid processing program executes a substrate delivering process of delivering substrate 2 from substrate holding means 23 of each of substrate processing chambers 11 to 22 to substrate transporting device 10, as shown in FIG. 2.

In the substrate liquid processing program in the substrate delivering process, in substrate processing chamber 11 shown in FIG. 2, elevation mechanism 32 of substrate holding means 23 is controlled by using control means 26 to drop cup 31 to a predetermined position, and thereafter, substrate 2 supported by using substrate holding bodies 29 is delivered to substrate transporting device 10. And thereafter, cup 31 is lifted to a predetermined position by controlling elevation mechanism 32 of substrate holding means 23 by using control means 26. The substrate delivering process may be performed simultaneously with the substrate receiving process.

In substrate liquid processing apparatus 1 described above, isopropyl alcohol is used as the substitution accelerating liquid while cyclohexanone is used as the second diluting liquid to perform the substitution accelerating process before and after the water-repelling process.

However, in the present disclosure, the water-repellent liquid is diluted with the first diluting liquid, and thereafter, diluted with the second diluting liquid to increase degrees of freedom in selecting the second diluting liquid. And the diluting liquid (e.g., alcohol) serving to dilute the water-repellent liquid as well as serving as the substitution accelerating liquid may be used as the second diluting liquid.

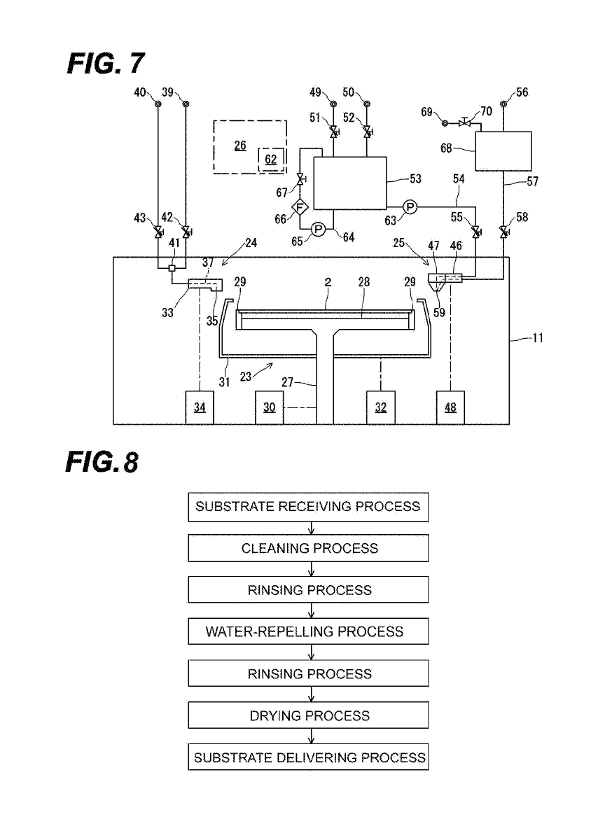

In the case where a diluting liquid serving as the substitution accelerating liquid as well is used as the second diluting liquid, substitution accelerating liquid supplying source 44, flow rate regulator 45, substitution path 38, and substitution discharge hole 36 may be removed from substrate processing chamber 11, as shown in FIG. 7, and substrate processing chamber 11 and substrate liquid processing apparatus 1 may be further minimized.

By this configuration, in substitution accelerating process, only the second diluting liquid that serves as the substitution accelerating liquid is supplied to substrate 2 from water-repellent liquid discharge nozzle 47 by opening and controlling flow rate regulator 58 with control means 26. In the meantime, in the water-repelling process, the second diluted water-repellent liquid generated by diluting the first diluted water-repellent liquid with the second diluting liquid is supplied to substrate 2 from the water-repellent liquid discharge nozzle 47 by opening and controlling flow rate regulators 55 and 58 with control means 26. In this case, water-repellent liquid discharge nozzle 47 serves not only as a mixing unit that generates the second diluted water-repellent liquid by mixing the first diluted water-repellent liquid and the second diluting liquid, but also as a supply unit that supplies the substitution accelerating liquid and the water-repellent liquid (second diluted water-repellent liquid) to substrate 2.

In the case where a diluting liquid that serves as the substitution accelerating liquid is used as the second diluting liquid, the diluted water-repellent liquid including the second diluting liquid supplied to substrate 2 in the water-repelling process has a property to be mixed with the rinse liquid supplied before and after the water-repelling process, and as a result, the substitution accelerating process before and after the water-repelling process may be omitted as shown in FIG. 8. Therefore, a processing time in substrate liquid processing apparatus 1 can be shortened and a throughput can be improved.

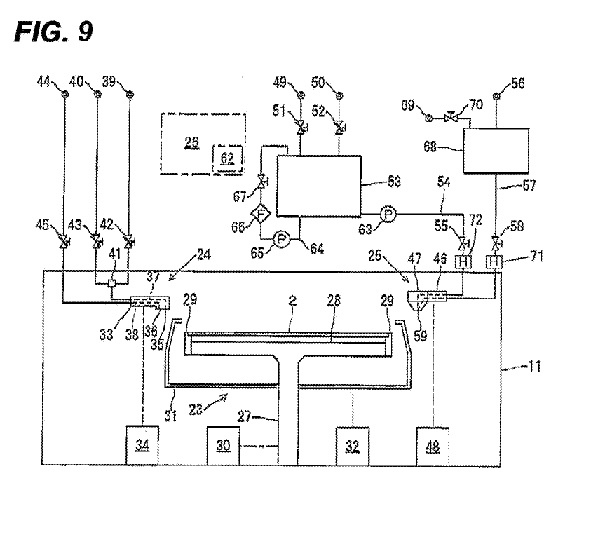

In substrate liquid processing apparatus 1 of the exemplary embodiments described above, the water-repelling process is performed without controlling the temperatures of each processing liquid and each diluting liquid. However, the water-repelling process may be performed with a heated high-temperature processing liquid. In this case, as shown in FIG. 9, a heater 71 that heats the second diluting liquid is installed between flow rate regulator 58 and water-repellent liquid discharge nozzle 47 installed in middle portions of second supply path 57. Heater 71 is connected to a power supply that supplies power to a heating element, a temperature sensor that monitors the temperature of the second diluting liquid, and a temperature controller that controls the power to the heating element from the power supply on the basis of a temperature measurement result from the temperature sensor (all are not shown). Therefore, the second diluting liquid that flows on second supply path 57 to reach water-repellent liquid discharge nozzle 47 is heated at a predetermined temperature. The temperature of the second diluting liquid at that time may be, for example, in the range up to a boiling point of the second diluting liquid used from room temperature (e.g., temperature in a clean room) in order to prevent the second diluting liquid from being volatilized by heating. Specifically, the temperature of the heated second diluting liquid may be in the range of approximately 30° C. to 60° C.

In order to prevent the heated second diluting liquid from getting cold in second supply path 57, an auxiliary heater may be installed between heater 71 and water-repellent liquid discharge nozzle 47. The auxiliary heater may be configured by, for example, a tape heater which winds around second supply path 57. The auxiliary heater is connected to a temperature controlling unit (temperature sensor, power supply, and temperature controller) that controls the temperature of the tape heater.

By this configuration, the first diluted water-repellent liquid that flows on first supply path 54 is diluted with the heated second diluting liquid supplied from second supply path 57 and the high-temperature second diluted water-repellent liquid can be supplied to substrate 2. Since the large flow rate of the second diluting liquid is supplied with respect to the first diluted water-repellent liquid, the second diluted water-repellent liquid is discharged to the substrate at substantially the same temperature as that of the second diluting liquid. The second diluted water-repellent liquid having the high temperature is supplied to substrate 2 to increase a water-repelling reaction speed, thereby shortening a time required for the water-repelling process.

Heater 71 that heats the second diluting liquid is installed between flow rate regulator 58 and water-repellent liquid discharge nozzle 47 to shorten a time to maintain the second diluting liquid at high temperature and prevent the second diluting liquid from being volatilized as compared with the case where the second diluting liquid is heated in storage tank 68.

The first diluted water-repellent liquid is diluted with the large flow rate of the heated second diluting liquid to increase the temperature of the second diluted water-repellent liquid without heating the water-repellent liquid or the first diluting liquid. As shown in FIG. 9, a heater 72 that heats the first diluted water-repellent liquid may be installed between water-repellent liquid discharge nozzle 47 and flow rate regulator 55 installed on first supply path 54. Heater 72 is configured similarly to heater 71 described above. The temperature of the first diluted water-repellent liquid at that time may be set to the same as that of the second diluting liquid. In this case, both the first diluted water-repellent liquid and the second diluting liquid that are mixed in water-repellent liquid discharge nozzle 47 are heated to more assuredly discharge the second diluted water-repellent liquid to substrate 2 while the second diluted water-repellent liquid is being heated.

A heater configured similarly to heater 71 is installed on substitution path 38 as well and the substitution accelerating liquid that flows on substitution path 38 to reach processing liquid discharge nozzle 33 may be heated by the heater. In order to prevent the heated substitution accelerating liquid from getting cold in substitution path 38, an auxiliary heater may be installed as well between the heater of substitution path 38 and processing liquid discharge nozzle 33. The temperature of the substitution accelerating liquid heated by the heater may be equal to or slightly higher than that of the second diluted water-repellent liquid. Therefore, the substitution accelerating liquid heated before the heated second diluted water-repellent liquid is supplied may be supplied to substrate 2 to heat substrate 2. Accordingly, when the heated second diluted water-repellent liquid is supplied to substrate 2, the temperature of the second diluted water-repellent liquid can be prevented from being decreased.

In the substitution accelerating process performed with respect to water-repelled substrate 2, the substitution accelerating liquid may not be heated. After liquid processing, since the temperature of substrate 2 should be decreased up to the room temperature, a time required to decrease the temperature of substrate 2 can be shortened by using the rinse liquid having the room temperature as well as the substitution accelerating liquid having the room temperature after the water-repelling process.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A substrate liquid processing apparatus that performs a water-repelling process for a substrate by using a diluted water-repellent liquid, comprising:
a water-repellent liquid supplying source configured to supply a water-repellent liquid;
a first diluting liquid supplying source configured to supply a first diluting liquid that is capable of diluting the water-repellent liquid without hydrolysis;
a mixing tank configured to generate a first diluted water-repellent liquid by mixing the water-repellent liquid supplied from the water-repellent liquid supplying source and the first diluting liquid supplied from the first diluting liquid supplying source;
a substrate processing chamber configured to conduct a water-repelling process for the substrate;
a first supply path configured to supply the first diluted water-repellent liquid from the mixing tank;
a first supplying mechanism configured to supply the first diluted water-repellent liquid from the mixing tank to the substrate processing chamber through the first supply path;
a second diluting liquid supplying source configured to supply a second diluting liquid that is capable of diluting the water-repellent liquid;
a second supply path configured to supply the second diluting liquid from the second diluting liquid supplying source;
a second supplying mechanism configured to supply the second diluting liquid from the second diluting liquid supplying source to the second supply path; and
a mixing unit installed on the first supply path and configured to generate a second diluted water-repellent liquid by mixing the first diluted water-repellent liquid and the second diluting liquid.

2. The substrate liquid processing apparatus of claim 1, wherein the mixing unit is a nozzle installed at an end portion of the first supply path and configured to mix a plurality of fluids therein, and each of the first supply path and the second supply path is connected to the nozzle.

3. The substrate liquid processing apparatus of claim 1, wherein the second diluting liquid supplying source supplies a second diluting liquid that hydrolyzes the water-repellent liquid.

4. The substrate liquid processing apparatus of claim 1, further comprising:
a rinse liquid supplying mechanism configured to supply a rinse liquid that rinses the substrate;
a substitution accelerating liquid supplying mechanism configured to supply a substitution accelerating liquid that accelerates substitution of the rinse liquid and the first or second diluted water-repellent liquid; and
a controller configured to control the first supplying mechanism, the rinse liquid supplying mechanism, and the substitution accelerating liquid supplying mechanism,
wherein the controller performs substitution accelerating by supplying the substitution accelerating liquid to the substrate before and after performing the water repelling process by supplying the first or second diluted water-repellent liquid to the substrate.

5. A substrate liquid processing apparatus that performs a water-repelling process for a substrate by using a diluted water-repellent liquid and a substitution accelerating process by supplying a substitution accelerating liquid to the substrate, comprising:
a substrate processing chamber configured to conduct the water-repelling process and the substitution accelerating process for the substrate;
a supply unit configured to supply the diluted water-repellent liquid or substitution accelerating liquid to the substrate;
a water-repellent liquid supplying source configured to supply the water-repellent liquid;
a first diluting liquid supplying source configured to supply a first diluting liquid that is capable of diluting the water-repellent liquid without hydrolysis;
a mixing tank configured to generate a first diluted water-repellent liquid by mixing the water-repellent liquid supplied from the water-repellent liquid supplying source and the first diluting liquid supplied from the first diluting liquid supplying source;
a first supply path configured to supply the first diluted water-repellent liquid from the mixing tank to the supply unit;
a first supplying mechanism configured to supply the first diluted water-repellent liquid from the mixing tank to the supply unit through the first supply path;
a second diluting liquid supplying source configured to supply a second diluting liquid that dilutes the first diluted water-repellent liquid and also serves as the substitution accelerating liquid;
a second supply path configured to supply the second diluting liquid from the second diluting liquid supplying source;
a second supplying mechanism configured to supply the second diluting liquid from the second diluting liquid supplying source to the second supply path;
a mixing unit installed on the first supply path and configured to generate a second diluted water-repellent liquid by mixing the first diluted water-repellent liquid and the second diluting liquid; and
a controller configured to control the first supplying mechanism and the second supplying mechanism,
wherein the controller controls to selectively perform the water repelling process that generates the second diluted water-repellent liquid by diluting the first diluted water-repellent liquid supplied from the mixing tank with the second diluting liquid supplied from the second supply path and supplies the generated liquid to the substrate, and perform the substitution accelerating process that supplies only the second diluting liquid supplied from the second supply path to the substrate.

6. The substrate liquid processing apparatus of claim 5, wherein the mixing unit is a nozzle installed at an end portion of the first supply path and being capable of mixing a plurality of fluids therein, and each of the first supply path and the second supply path is connected to the nozzle.

7. A substrate liquid processing method for a water-repelling process of a substrate by using a diluted water-repellent liquid, comprising:
generating a first diluted water-repellent liquid by mixing a first diluting liquid capable of diluting a water-repellent liquid without hydrolysis and the water-repellent liquid in a mixing tank;
generating a second diluted water-repellent liquid by mixing the first diluted water-repellent liquid supplied from the mixing tank and a second diluting liquid diluting the water-repellent liquid; and
performing the water repelling process by supplying the second diluted water-repellent liquid to the substrate.

8. The substrate liquid processing method of claim 7, wherein the second diluted water-repellent liquid is generated by mixing the first diluted water-repellent liquid and the second diluting liquid through a nozzle that is capable of mixing a plurality of fluids therein.

9. The substrate liquid processing method of claim 7, wherein a diluting liquid that hydrolyzes the water-repellent liquid is used as the second diluting liquid.

10. The substrate liquid processing method of claim 7, wherein a diluting liquid that accelerates substitution of a rinse liquid and the second diluted water-repellent liquid is used as the second diluting liquid to omit substitution between the water repelling process and a rinsing process.

11. The substrate liquid processing method of claim 7, wherein any one of propylene glycol monomethyletheracetate, ethers, and esters is used as the first diluting liquid, and any one of alcohol and cyclohexanone is used as the second diluting liquid.

12. A computer readable recording medium having a substrate liquid processing program that, when executed, causes a computer to perform a water-repelling process of a substrate with a diluted water-repellent liquid by using a substrate liquid processing apparatus, the process comprising:
generating a first diluted water-repellent liquid by mixing a first diluting liquid capable of diluting a water-repellent liquid without hydrolysis and the water-repellent liquid in a mixing tank;
generating a second diluted water-repellent liquid by mixing the first diluted water-repellent liquid supplied from the mixing tank and a second diluting liquid capable of diluting the water-repellent liquid; and
performing the water-repelling process by supplying the second diluted water-repellent liquid to the substrate.
